(19) United States
(12) Patent Application Publication
(10) Pub. No.: US 2014/0313465 A1
(43) Pub. Date: Oct. 23, 2014

(54) DISPLAY PANEL AND METHOD FOR MANUFACTURING LIQUID CRYSTAL DISPLAY USING THE SAME

(71) Applicant: Samsung Display Co., Ltd., Yongin-city (KR)

(72) Inventor: Jae-Kyung Go, Yongin-city (KR)

(73) Assignee: Samsung Display Co., Ltd., Yongin-city (KR)

(21) Appl. No.: 14/011,137

(22) Filed: Aug. 27, 2013

(30) Foreign Application Priority Data
Apr. 19, 2013 (KR) 10-2013-0043641

(51) Int. Cl. G02F 1/1337

(52) U.S. Cl. CPC G02F 1/133784
USPC 349/126; 349/139; 445/24

(57) ABSTRACT

A display panel and a method for manufacturing a liquid crystal display are provided. The display panel includes a substrate, a first display cell arranged on the substrate, a second display cell arranged on the substrate and located to be spaced apart from the first display cell in a first direction, and a separation region defined between the first display cell and the second display cell and including a flat portion and a projection portion projecting from the flat portion, where the first display cell includes a pad portion, which is formed on one side adjacent to the second display cell and which includes a convex portion having a surface that projects and a concave portion that is recessed.

### CROSS-REFERENCE TO RELATED APPLICATIONS

This application is based on and claims priority from Korean Patent Application No. 10-2013-0043641, filed on Apr. 19, 2013 in the Korean Intellectual Property Office, the disclosure of which is incorporated herein in its entirety by reference.

### BACKGROUND

1. Field

The present disclosure relates to a display panel including a plurality of display cells and a method for manufacturing a liquid crystal display using the same.

2. Description of the Related Technology

A liquid crystal display panel includes an array substrate, a color filter substrate facing the array substrate, and a liquid crystal layer formed between the array substrate and the color filter substrate. Included in the array substrate are a display region that displays an image in response to various driving signals and a peripheral region that surrounds the display region. In the display region of the array substrate, a plurality of data lines, a plurality of scanning lines, and a plurality of display elements electrically connected to the plurality of data lines and the plurality of scanning lines are arranged in the form of a matrix.

For mass production, liquid crystal display panels are manufactured from a large-sized display panel. A plurality of cell regions are defined on the display panel, and a plurality of liquid crystal display panels are produced from the display panel through a cutting process to cut the display panel in the unit of a cell.

### SUMMARY OF CERTAIN INVENTIVE ASPECTS

One subject to be solved by the present invention is to provide a display panel which can reduce damage of a rubbing roller during a rubbing process.

Another subject to be solved by the present invention is to provide a method for manufacturing a liquid crystal display which can improve productivity of the liquid crystal display through reduction of damage of a rubbing roller.

Additional advantages, subjects, and features of the invention will be set forth in part in the description which follows and in part will become apparent to those having ordinary skill in the art upon examination of the following or may be learned from practice of the invention.

In one aspect of the present invention, there is provided a display panel which includes a substrate, a first display cell arranged on the substrate, a second display cell arranged on the substrate and located to be spaced apart from the first display cell in a first direction, and a separation region defined between the first display cell and the second display cell and including a flat portion and a projection portion projecting from the flat portion, wherein the first display cell includes a pad portion formed on a side of the first display cell adjacent to the second display cell, said pad portion comprising a convex portion and a concave portion, where the projection portion is formed to correspond to a region in which the concave portion is formed along the first direction. As used herein, the term “convex” is used to refer to features that generally project, while the term “concave” is used to refer to features that are generally recessed or form a recess.

In another aspect of the present invention, there is provided a method for manufacturing a liquid crystal display which includes preparing a display panel that includes a concave portion and a convex portion, forming a projection portion that corresponds to the concave portion in a separation region, forming an alignment film on the display panel, and rubbing the display panel on which the alignment film is formed in a predetermined direction.

According to embodiments of the present invention, at least the following effects can be achieved.

The damage of the rubbing roller in the rubbing process can be minimized.

The display inferiority problem that may occur on display cells due to the damage of the rubbing roller can be improved.

By improving the rubbing inferiority, productivity of the liquid crystal display can be improved.

The effects according to the present invention are not limited to the contents as exemplified above, but further various effects are included in the description.

### BRIEF DESCRIPTION OF THE DRAWINGS

The above and other objects, features and advantages of the present invention will be more apparent from the following detailed description taken in conjunction with the accompanying drawings, in which:

FIG. 1 is a plan view of a display panel according to an embodiment of the present invention;

FIG. 2 is a partial enlarged view of a portion A of FIG. 1;

FIG. 3 is a cross-sectional view taken along line a-a′ of FIG. 2;

FIG. 4 is a cross-sectional view taken along line b-b′ of FIG. 2;

FIG. 5 is a plan view of a display panel according to another embodiment of the present invention;

FIG. 6 is a cross-sectional view taken along line c-c′ of FIG. 5;

FIG. 7 is a cross-sectional view taken along line d-d′ of FIG. 5;

FIG. 8 is a cross-sectional view taken along line e-e′ of FIG. 5;

FIG. 9 is a plan view of a display panel according to another embodiment of the present invention;

FIG. 10 is a partial enlarged view of a display panel according to another embodiment of the present invention;

FIG. 11 is a partial enlarged view of a display panel according to another embodiment of the present invention;

FIG. 12 is a partial enlarged view of a display panel according to another embodiment of the present invention;

FIG. 13 is a partial enlarged view of a display panel according to another embodiment of the present invention;

FIG. 14 is a cross-sectional view of a first display cell pad portion of a display panel according to another embodiment of the present invention;

FIG. 15 is a cross-sectional view of a display panel separation region according to another embodiment of the present invention;

FIG. 16 is a cross-sectional view of a display panel separation region according to another embodiment of the present invention;

FIG. 17 is a cross-sectional view of a display panel separation region according to another embodiment of the present invention;

FIG. 18 is a plan view of a display panel according to another embodiment of the present invention; and

FIG. 19 is a plan view of a display panel according to another embodiment of the present invention.

### DETAILED DESCRIPTION OF CERTAIN INVENTIVE EMBODIMENTS

The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are provided to assist those of ordinary skill in the art in a comprehensive understanding of the invention, and the present invention is only defined within the scope of the appended claims.

The term “on” that is used to designate that an element is on another element or located on a different layer or a layer includes both a case where an element is located directly on another element or a layer and a case where an element is located on another element via another layer or still another element. In the entire description of the present invention, the same drawing reference numerals are generally used for the same elements across various figures.

Although the terms “first, second,” and so forth are used to describe diverse constituent elements, such constituent elements are not limited by the terms. The terms are used only to discriminate a constituent element from other constituent elements. Accordingly, in the following description, a first constituent element may be a second constituent element.

Hereinafter, embodiments of the present invention will be described with reference to the accompanying drawings.

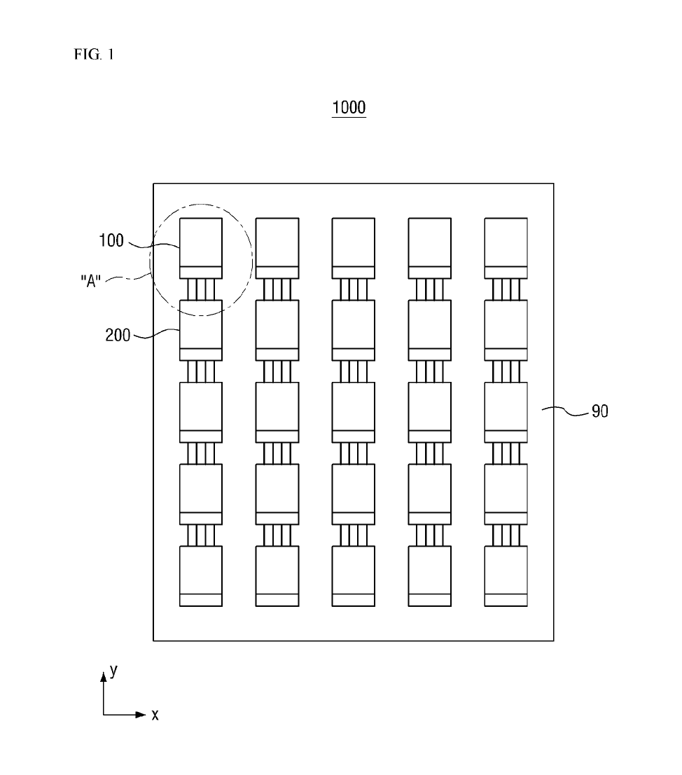

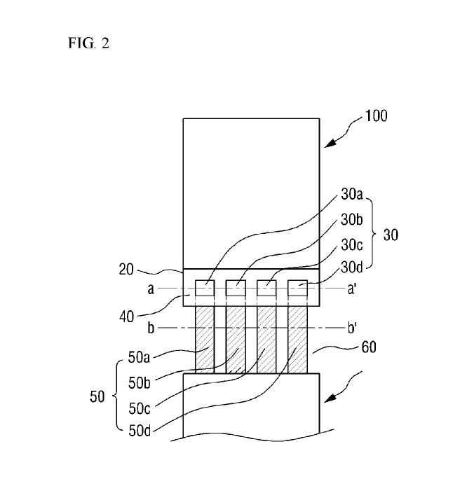

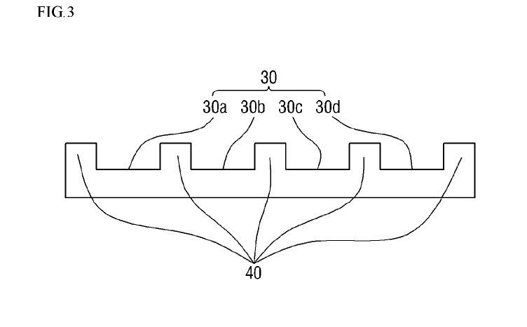

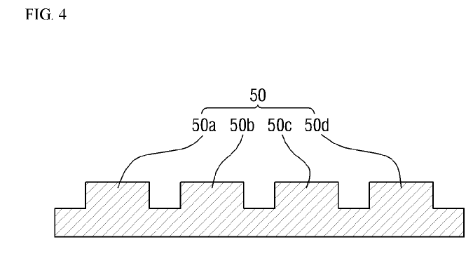

FIG. 1 is a plan view of a display panel according to an embodiment of the present invention, and FIG. 2 is a partial enlarged view of a portion A of FIG. 1. FIG. 3 is a cross-sectional view taken along line a-a′ of FIG. 2, and FIG. 4 is a cross-sectional view taken along line b-b′ of FIG. 2.

Referring to FIGS. 1 to 4, a display panel 1000 according to an embodiment of the present invention includes a substrate 90, a first display cell 100 arranged on the substrate 90, a second display cell 200 arranged on the substrate 90 and located to be spaced apart from the first display cell 100 in a first direction of the first display cell 100, and a separation region defined between the first display cell 100 and the second display cell 200 and including a flat portion 60 and a projection portion 50 projecting from the flat portion 60, wherein the first display cell 100 includes a pad portion 20, which is formed on one side that is adjacent to the second display cell 200 and includes a convex portion 40 and a concave portion 30.

The substrate 90 may be made of transparent glass or plastic. The substrate 90 may include a plurality of cell forming regions and separation regions defined between the cell forming regions. The cell forming regions may be arranged in a matrix structure, and thus the separation regions may be arranged to surround one cell forming region.

Display cells may be formed in the cell forming regions on the substrate 90. More specifically, a plurality of display cells may be arranged to be spaced apart from each other at a predetermined distance. For convenience of explanation, it is assumed that a certain display cell formed on the cell forming region of the substrate 90 is called a first display cell 100, and a display cell that is arranged to be spaced apart from the first display cell 100 in a first direction is called a second display cell 200. In an example embodiment, the first direction may be a downward direction of the y-axis in FIG. 1.

The first display cell 100 and the second display cell 200 may have substantially the same structure. More specifically, the first display cell 100 and the second display cell 200 may include thin film transistors (not illustrated). In an example embodiment, a plurality of gate electrode patterns (not illustrated) and a plurality of data electrode patterns (not illustrated) may be formed on the first display cell 100 and the second display cell 200. The plurality of gate electrode patterns and the plurality of data electrode patterns may be covered by a gate insulating film (not illustrated). Source/drain electrode patterns (not illustrated) may be formed on the gate insulating film. The source/drain electrode patterns may be covered by an interlayer insulating film (not illustrated).

The pad portion 20 of the first display cell 100 and a projection portion 50 and a flat portion 60, which are arranged on the separation region, are described in more detail with reference to FIGS. 2 to 4.

Referring to FIGS. 2 to 4, the pad portion 20 having a convex portion 40 and a concave portion 30 is arranged on one side of the first display cell 100, and the separation region that is defined between the first display cell 100 and the second display cell 200 includes the flat portion 60 and the projection portion 50 that projects from the flat portion 60.

The pad portion 20 may be arranged on one side of the first display cell 100. The pad portion 20 may include a gate pad (not illustrated) or a data pad (not illustrated) which is respectively electrically connected to the gate electrode pattern or the data electrode pattern.

In some embodiments, the display panel may be a COG (Chip On Glass) type. If the display panel is the COG type, a plurality of wirings and driving integrated circuits may be further arranged on the pad portion 20.

Due to the data pad, the gate pad, and various kinds of wirings and driving integrated circuits arranged on the pad portion 20, at least one convex portion 40 and at least one concave portion 30 may be formed on the surface of the pad portion 20.

The convex portion 40 and/or the concave portion 30 may be arranged in certain positions of the pad portion 20, and may have various shapes. The convex portion 40 and/or the concave portion 30 may have, for example, a triangular or rectangular shape, but are not limited thereto.

The pad portion 20 of the first display cell 100 may be formed on one side of the first display cell 100 that is adjacent to the second display cell 200.

As described above, the separation region may be defined between the first display cell 100 and the second display cell 200. The separation region that is defined between the first display cell 100 and the second display cell 200 may include the flat portion 60 and the projection portion 60 that projects from the flat portion 60.

The projection portion 50 may be formed to correspond to the concave portion 30 of the pad portion 20. In the case where the projection portion 50 of the separation region is formed to correspond to the concave portion 30 of the pad portion 20, damage of a rubbing fabric caused by the concave portion 30 of the pad portion 20 and a vertical line stain occurring due to the damage of the rubbing fabric can be prevented in the rubbing process. More specifically, in the rubbing process to rub an alignment film, a rubbing roller may move in a constant direction as pressing the display panel 1000. If the rubbing fabric of the rubbing roller passes the concave portion 30 that is arranged on the pad portion 20 of the display panel 1000, the rubbing fabric that comes in contact with the concave portion 30 projects at a predetermined distance due to pressure of the rubbing roller, and the projecting rubbing fabric continuously moves along the movement of the rubbing roller to cause stain on the display panel 1000. If the projecting portion 50 that corresponds to the concave portion 30 is formed in the separation region, the rubbing fabric that comes in contact with the projection portion 50 is recessed at a predetermined distance as the rubbing roller passes the projection portion 50, and the recessed portion comes in contact with the concave portion 30 as the rubbing fabric passes the projection portion 50. Accordingly, even though the rubbing fabric that comes in contact with the concave portion 30 is pressed, the projection of the rubbing fabric may be suppressed or prevented, and thus the stain that would occur due to the projection of the rubbing fabric may be reduced or eliminated.

A plurality of concave portions 30 of the pad portion 20 may be provided. In an example embodiment, the concave portions 30 may have a rectangular shape, and may be arranged to be spaced apart from each other at a predetermined distance.

For convenience of explanation, it is assumed that the concave portions 30 of the pad portion 20 as illustrated in FIGS. 2 to 4 are called a first concave portion 30a, a second concave portion 30b, a third concave portion 30c, and a fourth concave portion 30d in left-to-right order. Further, the projection portions 50 of the separation region, which correspond to the respective concave portions 30, are called a first projection portion 50a, a second projection portion 50b, a third projection portion 50c, and a fourth projection portion 50d. The number of the concave portions 30 and the projection portions 50 are provided as examples, and the scope of the present invention is not limited by the number of the concave portions 30 and the projection portions 50.

The first to fourth concave portions 30a, 30b, 30c, and 30d may have a rectangular shape. Further, the first to fourth concave portions 30a, 30b, 30c, and 30d may be arranged to be spaced apart from each other at a predetermined distance, and may be aligned in a second direction that is perpendicular to the first direction.

The depth of the first concave portion 30a, the depth of the second concave portion 30b, the depth of the third concave portion 30c, and the depth of the fourth concave portion 30d may be substantially equal to each other. Further, the width of the first concave portion 30a, the width of the second concave portion 30b, the width of the third concave portion 30c, and the width of the fourth concave portion 30d may be substantially equal to each other.

In the separation region that is adjacent to the pad portion 20, the flat portion 60 and the projection portion 50 that generally projects from the flat portion 50 may be arranged.

The first to fourth projection portions 50a, 50b, 50c, and 50d may have a rectangular shape. Further, the first to fourth projection portions 50a, 50b, 50c, and 50d may be arranged to be spaced apart from each other at a predetermined distance. Further, the first to fourth projection portions 50a, 50b, 50c, and 50d may extend in the length direction so that one end of each of the first to fourth projection portions 50a, 50b, 50c, and 50d comes in contact with the first display cell 100 and the other end thereof comes in contact with the second display cell 200.

The first to fourth projection portions 50a, 50b, 50c, and 50d may be arranged to correspond to the first to fourth concave portions 30a, 30b, 30c, and 30d. More specifically, the first projection portion 50a may be arranged to correspond to the first concave portion 30a along the first direction. The width of the first concave portion 30a may be substantially equal to the width of the first projection portion 50a. Further, the depth of the first concave portion 30a may be substantially equal to the depth of the first projection portion 50a. In the same manner, the second projection portion 50b may be arranged to correspond to the second concave portion 30b, the third projection portion 50c may be arranged to correspond to the third concave portion 30c, and the fourth projection portion 50d may be arranged to correspond to the fourth concave portion 30d.

Hereinafter, other embodiments of the present invention will be described. The same reference numerals are generally used for the same constituent elements as the constituent elements as described above, and the duplicate explanation thereof will be omitted or simplified.

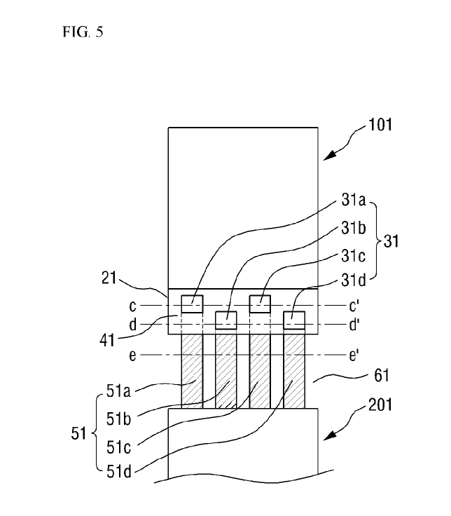

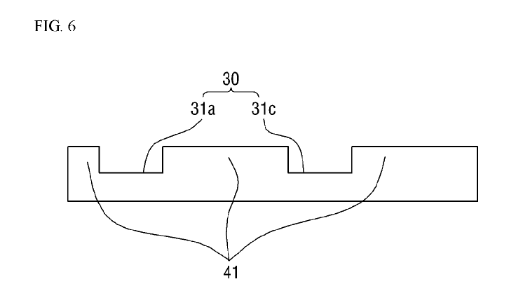

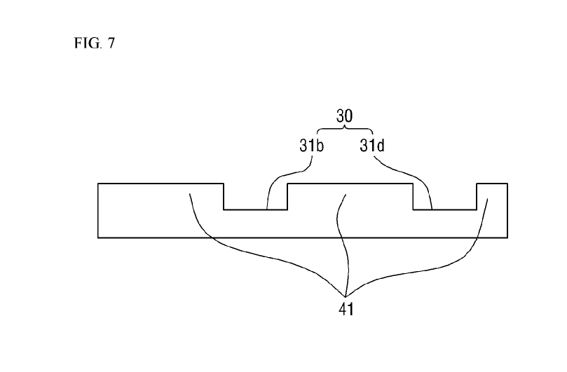

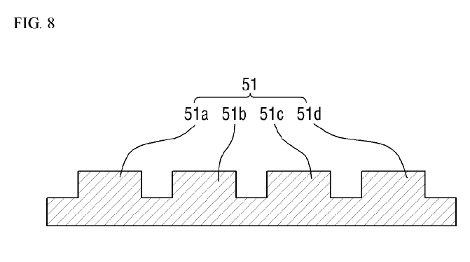

FIG. 5 is a plan view of a display panel according to another embodiment of the present invention. FIG. 6 is a cross-sectional view taken along line c-c′ of FIG. 5, FIG. 7 is a cross-sectional view taken along line d-d′ of FIG. 5, and FIG. 8 is a cross-sectional view taken along line e-e′ of FIG. 5.

Referring to FIGS. 5 to 8, a display panel according to another embodiment of the present invention is different from the display panel according to the embodiment of FIG. 1 in that concave portions 31 are alternately arranged along the second direction.

The concave portions 31 may be alternately arranged along the second direction. For example, the first concave portion 31a and the third concave portion 31c may be arranged to be aligned in the second direction, and the second concave portion 31b and the fourth concave portion 31d may be arranged to be aligned in the second direction, but the first concave portion 31a and the second concave portion 31b may be alternately arranged with each other.

Even in the case where the concave portions 31 are alternately arranged along the second direction, the projection portions 51 of the separation region may be arranged to correspond to the respective concave portions 31. That is, the first to fourth projection portions 51a, 51b, 51c, and 51d may be arranged to correspond to the first to fourth concave portions 31a, 31b, 31c, and 31d. However, even in this case, the first to fourth projection portions 51a, 51b, 51c, and 51d may be arranged to be aligned in the second direction. Further, even in the case where the first to fourth concave portions 31a, 31b, 31c, and 31d are alternately arranged, the first direction length of the first projection portion 51a, the first direction length of the second projection portion 51b, the first direction length of the third projection portion 51c, and the first direction length of the fourth projection portion 51d may be substantially equal to each other. Further, as described above, one end of each of the first to fourth projection portions 51a, 51b, 51c, and 51d may come in contact with the first display cell 101, and the other end of each of the first to fourth projection portions 51a, 51b, 51c, and 51d may come in contact with the second display cell 201.

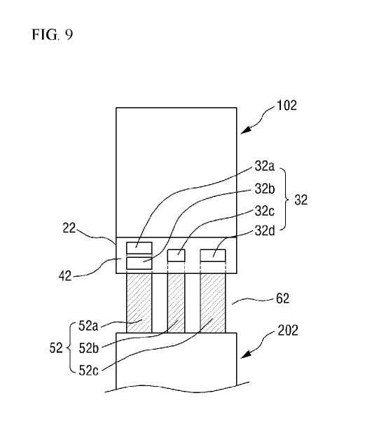

FIG. 9 is a plan view of a display panel according to another embodiment of the present invention.

Referring to FIG. 9, the display panel in this embodiment is different from the display panel according to the embodiment of FIG. 1 in that the first concave portion 32a and the second concave portion 32b are arranged to overlap each other in the first direction.

As described above, in the display panel according to some embodiments of the present invention, the concave portion 32 may be arranged in a certain position of the pad portion 22. In the case where a plurality of concave portions are arranged in certain positions of the pad portion, some concave portions may be arranged to overlap each other in the first direction. FIG. 8 exemplifies that the first concave portion 32a and the second concave portion 32b overlap each other in the first direction, and the widths of the first concave portion 32a and the second concave portion 32b are substantially equal to each other.

In the case where the first concave portion 32a and the second concave portion 32b are arranged to overlap each other, the first projection portion 52a may be arranged to correspond to the first concave portion 32a and the second concave portion 32b. In this case, the width of the first projection portion 52a may be substantially equal to the width of the first concave portion 32a and the second concave portion 32b.

The height of the first projection portion 52a may be substantially equal to the depth of the first concave portion 32a or the depth of the second concave portion 32b.

In the case where the first concave portion 32a and the second concave portion 32b are arranged to overlap each other, the second projection portion 52b may be arranged to correspond to the third concave portion 32c, and the third projection portion 52c may be arranged to correspond to the fourth concave portion 32d. In this case, the width of the second projection portion 52b may be substantially equal to the width of the third concave portion 32c, and the width of the third projection portion 52c may be substantially equal to the width of the fourth concave portion 32d. Further, the height of the second projection portion 52b may be substantially equal to the depth of the third concave portion 32c, and the height of the third projection portion 52d may substantially equal to the depth of the fourth concave portion 32d.

As described above, in the rubbing process, the rubbing fabric may be damaged as it passes the concave portion of the pad portion 22, and the degree of damage of the rubbing fabric may differ depending on the depth of the concave portion that the rubbing fabric passes or the number of concave portions. In the case where the concave portions 32 overlap each other like the display panel according to another embodiment of the present invention, the projection portions 52 are arranged to correspond to this, and thus the degree of damage of the rubbing fabric can be mitigated.

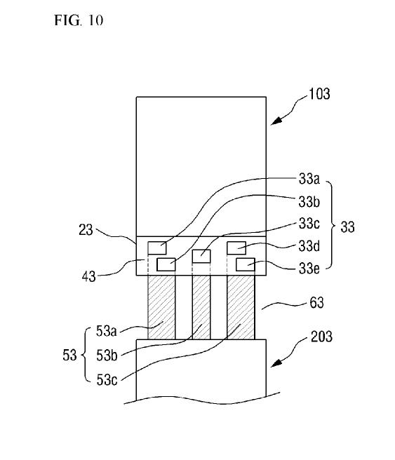

FIG. 10 is a partial enlarged view of a display panel according to another embodiment of the present invention.

Referring to FIG. 10, the display panel according to another embodiment of the present invention is different from the display panel according to the embodiment of FIG. 8 in that the first concave portion 33a and the second concave portion 33b, and the fourth concave portion 33d and the fifth concave portion 33e respectively partially overlap each other.

As described above, in the display panel according to some embodiments, the concave portion 33 may be arranged in a certain position of the pad portion 23. In the case where a plurality of concave portions 33 are arranged in certain positions of the pad portion 23, some concave portions may partially overlap each other in the first direction. FIG. 10 exemplifies that the first concave portion 33a and the second concave portion 33b, and the fourth concave portion 33c and the fifth concave portion 33e partially overlap each other.

In the case where the first concave portion 33a and the second concave portion 33b, and the fourth concave portion 33d and the fifth concave portion 33e are arranged to partially overlap each other, the first projection portion 53a may be arranged to correspond to the first concave portion 33a and the second concave portion 33b, and the third projection portion 53c may be arranged to correspond to the fourth concave portion 33d and the fifth concave portion 33e. In this case, the width of the first projection portion 53a may be substantially equal to a value that is obtained by subtracting the width of the portion where the first concave portion 33a and the second concave portion 33b overlap each other from a value obtained by adding the width of the first concave portion 33a and the width of the second concave portion 33b. Further, the height of the first projection portion 53a may be substantially equal to the depth of the first concave portion 33a or the depth of the second concave portion 33b. Exemplarily, the height of the first projection portion 53a may be substantially equal to a deeper one of the depth of the first concave portion 33a and the depth of the second concave portion 33b.

In the same manner, the width of the third projection portion 53c may be substantially equal to a value that is obtained by subtracting the width of the portion where the fourth concave portion 33d and the fifth concave portion 33e overlap each other from a value obtained by adding the width of the fourth concave portion 33d and the width of the fifth concave portion 33e. Further, the height of the third projection portion 53c may be substantially equal to the depth of the fourth concave portion 33d and the depth of the fifth concave portion 33e. Exemplarily, the height of the third projection portion 53c may be substantially equal to a deeper one of the depth of the fourth concave portion 33d and the depth of the fifth concave portion 33e.

In the case where the first concave portion 33a and the second concave portion 33b, and the fourth concave portion 33d and the fifth concave portion 33e are arranged to partially overlap each other, the second projection portion 53b may be arranged to correspond to the third concave portion 33c. In this case, the width of the second projection portion 53b may be substantially equal to the width of the third concave portion 33c, and the height of the second projection portion 53b may be substantially equal to the width of the third concave portion 33c.

In the case where the concave portions 33 partially overlap each other as in the display panel according to another embodiment of the present invention, the projection portion 53 is arranged to correspond to this, and thus the damage of the rubbing fabric that may occur in the rubbing process may be mitigated.

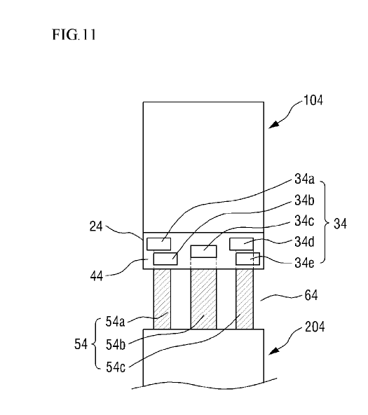

FIG. 11 is a partial enlarged view of a display panel according to another embodiment of the present invention.

Referring to FIG. 11, the display panel according to this embodiment is different from the display panel according to the embodiment of FIG. 10 in that the first projection portion 54a and the third projection portion 54c are arranged to correspond to a region where the first concave portion 34a and the second concave portion 34b, and the fourth concave portion 34d and the fifth concave portion 34e respectively partially overlap each other.

As described above in FIG. 10, the first concave portion 34a and the second concave portion 34b, and the fourth concave portion 34d and the fifth concave portion 34e may partially overlap each other. The first projection portion 54a may be arranged to correspond to the portion where the first concave portion 34a and the second concave portion 34b overlap each other, and the third projection portion 54c may be arranged to correspond to the portion where the fourth concave portion 34d and the fifth concave portion 34e overlap each other. In this case, the width of the first projection portion 54a may be substantially equal to the width of the portion where the first concave portion 34a and the second concave portion 34b overlap each other, and the width of the third projection portion 54c may be substantially equal to the width of the portion where the fourth concave portion 34d and the fifth concave portion 34e overlap each other.

Further, the height of the first projection portion 54a may be substantially equal to the depth of the first concave portion 34a or the depth of the second concave portion 34b. Exemplarily, the height of the first projection portion 54a may be substantially equal to a deeper one of the depth of the first concave portion 34a and the depth of the second concave portion 34b.

Further, the height of the third projection portion 54c may be substantially equal to the depth of the fourth concave portion 34d or the depth of the fifth concave portion 34e. Exemplarily, the height of the third projection portion 54c may be substantially equal to a deeper one of the depth of the fourth concave portion 34d and the depth of the fifth concave portion 34e.

In the case where the first concave portion 34a and the second concave portion 34b, and the fourth concave portion 34d and the fifth concave portion 34e are arranged to respectively partially overlap each other, the second projection portion 54b may be arranged to correspond to the third concave portion 34c. In this case, the width of the second projection portion 54b may be substantially equal to the width of the third concave portion 34c, and the height of the second projection portion 54b may be substantially equal to the width of the third concave portion 34c.

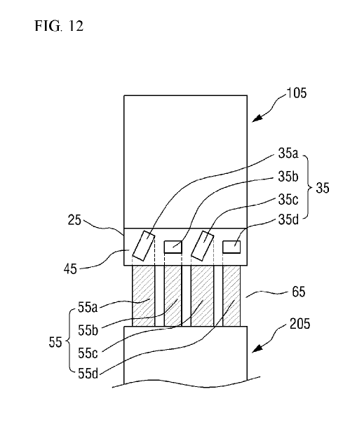

FIG. 12 is a partial enlarged view of a display panel according to another embodiment of the present invention.

Referring to FIG. 12, the display panel according to another embodiment of the present invention is different from the display panel according to the embodiment of FIG. 1 in that the first concave portion 35a and the third concave portion 35c are diagonally arranged.

As described above, the concave portion 35 arranged on the pad portion 25 may have a certain shape. FIG. 12 exemplifies that the first concave portion 35a and the third concave portion 35c, which are arranged on the pad portion 25, are diagonally arranged in the form of a rectangle.

The first projection portion 55a may be arranged to correspond to the first concave portion 35a along the first direction. In this case, the width of the first projection portion 55a may be substantially equal to the width that is occupied by the first concave portion 35a in the second direction. In the same manner, the third projection portion 55c may be arranged to correspond to the third concave portion 35c along the first direction. In this case, the width of the third projection portion 55c may be substantially equal to the width that is occupied by the third concave portion 35c in the second direction.

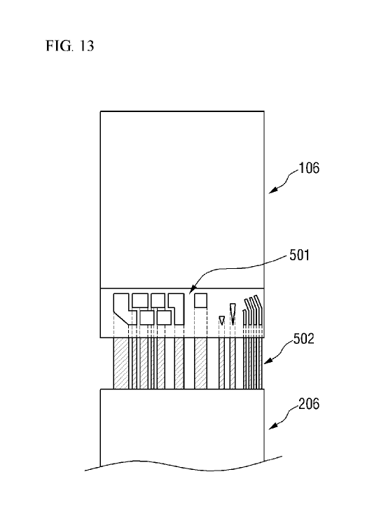

FIG. 13 is a partial enlarged view of a display panel according to another embodiment of the present invention.

Referring to FIG. 13, the display panel according to another embodiment of the present invention is different from the display panel according to the embodiment of FIG. 2 in that a plurality of concave portions 501 having certain shapes are included.

The display panel according to another embodiment of the present invention may be a COG (Chip On Glass) type. If the display panel is the COG type, a plurality of wirings and driving integrated circuits may be arranged on the pad portion of the first display cell 106. In this case, a plurality of concave portions 501 having certain shapes may be formed on the pad portion due to the plurality of wirings and driving integrated circuits.

A plurality of projection portions 502 that correspond to the plurality of concave portions 501 may be formed in the separation region. The plurality of projection portions 502 may be formed to correspond to at least a part of the plurality of concave portions 501.

The plurality of concave portions 501 may be independently arranged based on the first direction, or a part or the whole thereof may be arranged to overlap each other. In the case where the concave portions 501 are independently arranged, the projection portions 502 that correspond to the concave portions 501 may be arranged in the separation region along the first direction.

In the case where the concave portions are independently arranged, the position and the shape of the corresponding projection portions may be substantially equal to the projection portions illustrated in FIG. 1.

The plurality of concave portions 501 may be arranged to partially or entirely overlap each other along the first direction.

In this case, the plurality of projection portions 502 that correspond to the plurality of concave portions 501 may be formed to include a portion where the concave portions overlap each other (see FIG. 10), or may be formed to correspond to a region where the concave portions overlap each other.

Further, in one embodiment, some concave portions may be disregarded and the corresponding projection portions may not be formed in the separation region. If the width of the concave portion is narrow or the depth of the concave portion is shallow, the influence exerted on the rubbing fabric in the rubbing process may be slight or may not exist, and in this case, the corresponding projection portion may be omitted.

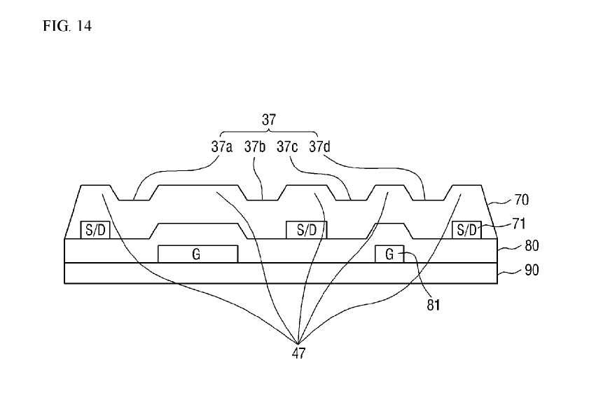

FIG. 14 is a cross-sectional view of a first display cell pad portion of a display panel according to another embodiment of the present invention.

Referring to FIG. 14, the display panel according to another embodiment of the present invention is different from the display panel according to the embodiment of FIG. 2 in that the pad portion of the first display cell includes tapered convex portions 47 and inverse tapered concave portions 37.

FIG. 14 exemplifies that the convex portions 47 that include gate electrode patterns 81 or source/drain electrode patterns 71 are arranged, and thus first to fourth concave portions 37 are formed.

The pad portion may include a plurality of electrode patterns. The electrode pattern may be, for example, a gate electrode pattern 81 or a source/drain electrode pattern 71.

In one embodiment, the gate electrode pattern 81 may be arranged on the substrate. The gate electrode pattern 81 may be covered by a gate insulating film 80. The source/drain electrode pattern 71 may be arranged on the gate insulating film 80. The source/drain electrode pattern 71 may be covered by an interlayer insulating film 70.

A step-height may be formed on the pad portion due to the gate electrode pattern 81 and/or the source/drain electrode pattern 71. That is, the tapered convex portions 47 may be formed in a portion where the interlayer insulating film 70 overlaps the gate electrode pattern 81 and/or the source/drain electrode 71. As the tapered convex portions 47 are formed on the interlayer insulating film 70, the concave portions 37 may be formed, and the concave portion 37 may have an inverse tapered shape.

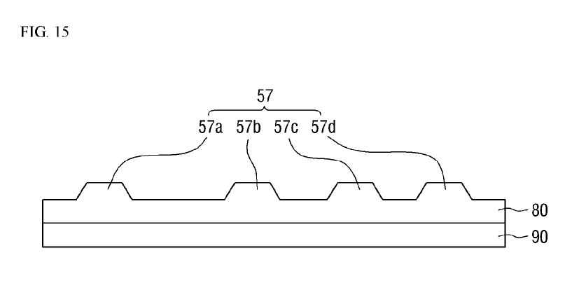

FIG. 15 is a cross-sectional view of a display panel separation region according to another embodiment of the present invention.

Referring to FIG. 15, the display panel separation region according to another embodiment of the present invention is different from the display panel according to the embodiment of FIG. 1 in that tapered projection portions are included.

As illustrated in FIG. 14, the pad portion may include inverse tapered concave portions 37. In the case where the pad portion includes the inverse tapered concave portion 37, projection portions 57 that correspond to the concave portions 37 may be arranged along the first direction on the separation region. The projection portions 57 that correspond to the inverse tapered concave portions 37 may have a tapered shape.

FIG. 15 exemplifies that first to fourth tapered projection portions 57a, 57b, 57c, and 57d are arranged in the separation region. The first to fourth projection portions 57a, 57b, 57c, and 57d may be arranged to correspond to the first to fourth concave portions 37a, 37b, 37c, and 37d as described above with reference to FIG. 14. In this case, the width of each of the projection portions 57 may be substantially equal to the width of the concave portion 37 that corresponds to the projection portion 57.

The gate insulating film 80 may be arranged even on the separation region of the substrate 90. In one embodiment, the first to fourth projection portions 57a, 57b, 57c, and 57d may be formed by processing the shape of the gate insulating film 80. In other words, the first to fourth projection portions 57a, 57b, 57c, and 57d may be formed by patterning the gate insulating film 80 itself. That is, the gate insulating film 80 and the first to fourth projection portions 57a, 57b, 57c, and 57d may be formed of the same material.

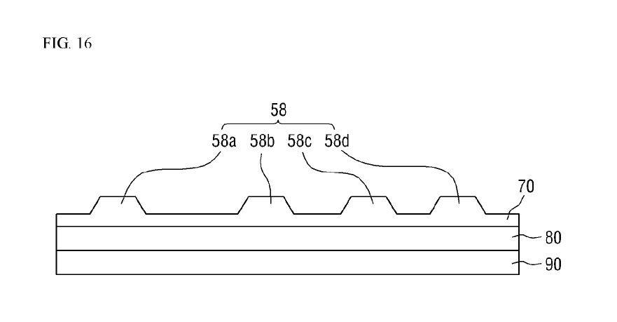

FIG. 16 is a cross-sectional view of a display panel separation region according to another embodiment of the present invention.

Referring to FIG. 16, the display panel according to another embodiment of the present invention is different from the display panel according to the embodiment of FIG. 15 in that first to fourth projection portions 58a, 58b, 58c, and 58d are formed by the interlayer insulating film 70.

The interlayer insulating film 70 may be arranged even on the separation region of the substrate 90. For example, the interlayer insulating film 70 may be arranged on the gate insulating film 80.

The first to fourth projection portions 58a, 58b, 58c, and 58d may be formed by processing the shape of the interlayer insulating film 70. In other words, the first to fourth projection portions 58a, 58b, 58c, and 58d may be formed by patterning the interlayer insulating film 70 itself. That is, the interlayer insulating film 70 and the first to fourth projection portions 58a, 58b, 58c, and 58d may be formed of the same material.

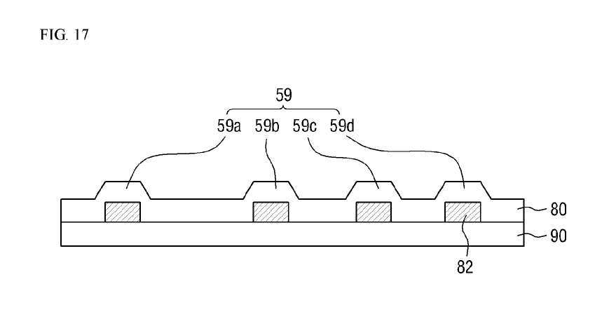

FIG. 17 is a cross-sectional view of a display panel separation region according to another embodiment of the present invention.

Referring to FIG. 17, the display panel according to another embodiment of the present invention is different from the display panel according to the embodiment of FIG. 16 in that a dummy metal is arranged on the separation region.

The dummy metal 82 may be arranged in the separation region on the substrate 90. The dummy metal 82 may be formed of the same material as the gate electrode pattern 81. The dummy metal 82 may be covered by the gate insulating film 80.

A step-height may be formed in the separation region due to the dummy metal 82. That is, a tapered projection portion 59 may be formed on a portion where the gate insulating film 80 overlaps the dummy metal 82.

FIG. 17 exemplifies that the first to fourth tapered projection portions 59a, 59b, 59c, and 59d are arranged in the separation region. The first to fourth projection portions 59a, 59b, 59c, and 59d may be arranged to correspond to the first to fourth concave portions 37a, 37b, 37c, and 37d as described above with reference to FIG. 14. In this case, the width of each of the projection portions 59 may be substantially equal to the width of the concave portion 37 that corresponds to the projection portion 59.

FIG. 17 exemplifies that the dummy metal 82 is arranged on the substrate to be covered by the gate insulating film 80. However, the position of the dummy metal 82 is not limited thereto. That is, in another embodiment, the dummy metal 82 may be arranged on the gate insulating film 80, and may be covered by the interlayer insulating film 70. In this case, the dummy metal 82 may be made of the same material as the source/drain electrode pattern 71.

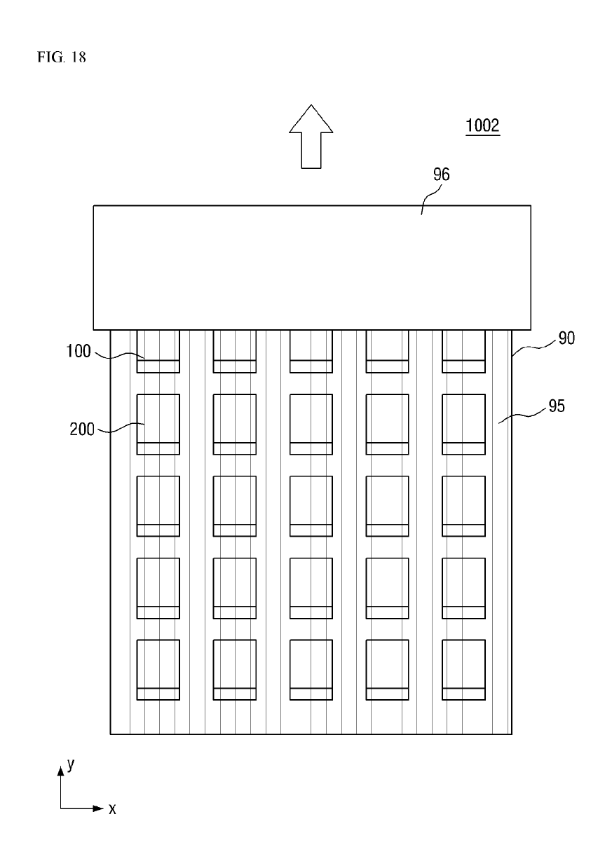

FIG. 18 is a plan view of a display panel according to another embodiment of the present invention.

Referring to FIG. 18, the display panel according to another embodiment of the present invention is different from the display panel according to the embodiment of FIG. 1 in that an alignment film that is rubbed in a predetermined direction is further included.

An alignment film 95 may be formed on the display panel. A liquid crystal layer may be arranged on the alignment film 95. The molecular arrangement of the liquid crystal layer is determined by rubbing of the alignment film 95, and the display quality is improved if the rubbing of the alignment film 95 is uniform as a whole.

In one embodiment, the rubbing of the alignment film 95 may be performed by a rubbing roller 96, and the rubbing direction may be a direction opposite to the first direction (hereinafter, defined as a third direction) (see an arrow in FIG. 18). That is, the display panel 1002 according to another embodiment of the present invention may further include the alignment film 95 that is rubbed in the third direction.

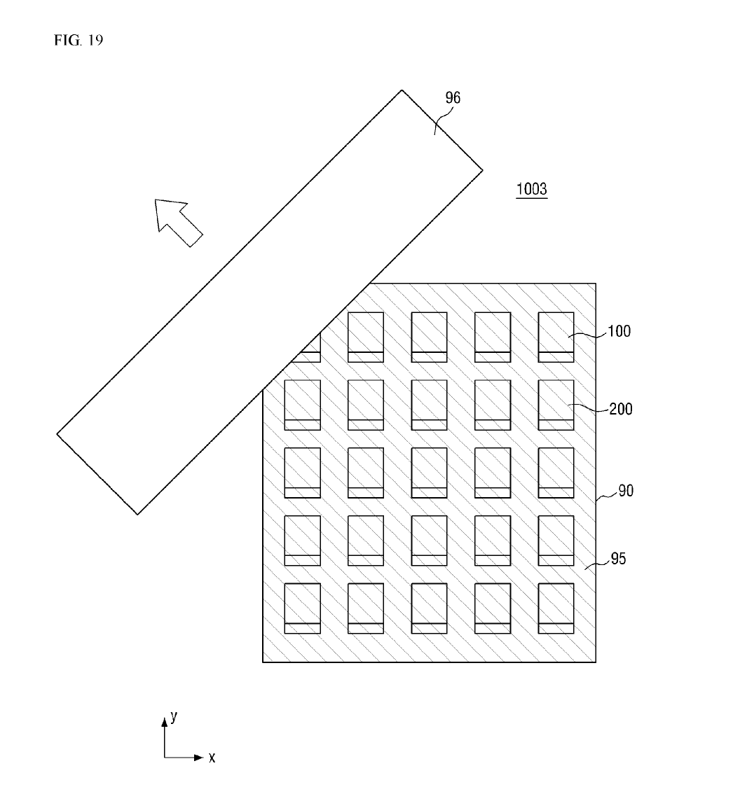

FIG. 19 is a plan view of a display panel according to another embodiment of the present invention.

Referring to FIG. 19, the display panel according to another embodiment of the present invention is different from the display panel according to the embodiment of FIG. 18 in that the alignment film 95 which is aligned in a fourth direction that is tilted at a predetermined angle from the third direction.

The rubbing of the alignment film 95 may be performed in the fourth direction that is tilted at a predetermined angle from the third direction. If the rubbing of the alignment film 95 is performed in the fourth direction, the display panel 1003 according to another embodiment of the present invention may include the alignment film 95 that is rubbed in the fourth direction.

The angle formed between the third direction and the fourth direction may be, for example, about 40 to about 50 degrees, but is not limited thereto.

Hereinafter, a method for manufacturing a liquid crystal display according to another embodiment of the present invention is described.

The method for manufacturing a liquid crystal display according to another embodiment of the present invention includes preparing a display panel that includes a concave portion and a convex portion, forming a projection portion that corresponds to the concave portion in a separation region, forming an alignment film on the display panel, and rubbing the display panel on which the alignment film is formed in a predetermined direction.

The display panel may be substantially the same as the display panel according to some embodiments of the present invention as described above. Accordingly, the detailed explanation thereof will be omitted.

Preparing the display panel may include forming a gate electrode pattern on the display panel, forming a gate insulating film on the gate electrode pattern, forming a source/drain electrode pattern on the gate insulating film, and forming an interlayer insulating film on the source/drain electrode pattern.

Forming the projection portion on the separation region may be performed successively or simultaneously with preparing the display panel. Forming the projection portion on the separation region may include forming a gate electrode pattern on the display panel, forming a gate insulating film on the gate electrode pattern, forming a source/drain electrode pattern on the gate insulating film, and/or forming an interlayer insulating film on the source/drain electrode pattern. The projection portion of the separation region may be formed in substantially the same method as the method as described above with reference to FIGS. 14 to 17.

Rubbing the display panel on which the alignment film is formed may include rubbing the alignment film in the third direction or rubbing the alignment film in the fourth direction. The rubbing method in the third direction and in the fourth direction may be substantially the same as that described above with reference to FIGS. 18 and 19.

Although certain embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A display panel comprising:
a substrate;
a first display cell arranged on the substrate;
a second display cell arranged on the substrate and located to be spaced apart from the first display cell in a first direction; and
a separation region defined between the first display cell and the second display cell and including a flat portion, and a projection portion projecting from the flat portion,
wherein the first display cell comprises a pad portion formed on a side of the first display cell adjacent to the second display cell, said pad portion comprising a convex portion, and a concave portion, and
wherein the projection portion is formed to correspond to a region in which the concave portion is formed along the first direction.

2. The display panel of claim 1, wherein a height of the projection portion is equal to a depth of the concave portion that corresponds to the projection portion.

3. The display panel of claim 1, wherein a width of the projection portion is equal to a width of the concave portion that corresponds to the projection portion.

4. The display panel of claim 1, wherein the convex portion comprises an electrode pattern arranged on a base.

5. The display panel of claim 4, wherein the electrode pattern is a gate electrode pattern or a source/drain electrode pattern.

6. The display panel of claim 4, wherein the convex portion further comprises an insulating film formed on at least one of a lower portion and an upper portion of the electrode pattern.

7. The display panel of claim 6, wherein the insulating film is a gate insulating film or an interlayer insulating film.

8. The display panel of claim 1, wherein the projection portion comprises a dummy metal arranged on the substrate.

9. The display panel of claim 8, wherein the convex portion comprises a gate electrode pattern or a source/drain electrode pattern arranged on a base, and the dummy metal is made of the same material as the gate electrode pattern or the source/drain electrode pattern.

10. The display panel of claim 1, wherein the pad portion comprises a plurality of concave portions, and the projection portion is formed to correspond to at least one of the plurality of concave portions.

11. The display panel of claim 1, wherein the first display cell and the second display cell comprise alignment films rubbed in a third direction opposite to the first direction.

12. The display panel of claim 1,
wherein the first display cell and the second display cell comprise alignment films rubbed in a fourth direction,
wherein the fourth direction is tilted by a predetermined angle relative to a third direction opposite to the first direction.

13. A display panel comprising:
a substrate;
a plurality of display cells arranged on the substrate to be spaced apart from each other at a predetermined distance and having pad portions that include concave portions; and
a separation region defined between the plurality of display cells and including projection portions that correspond to the concave portions.

14. The display panel of claim 13, wherein a height of the projection portion is equal to a depth of the concave portion that corresponds to the projection portion.

15. The display panel of claim 13, wherein a width of the projection portion is equal to a width of the concave portion that corresponds to the projection portion.

16. The display panel of claim 13, wherein the projection portion comprises a dummy metal arranged on the substrate.

17. The display panel of claim 13, further comprising an alignment film rubbed in a predetermined direction.

18. A method of manufacturing a liquid crystal display, comprising:
preparing a display panel that includes a first display cell and a second display cell, the first and second display cells arranged to be spaced apart from each other at a predetermined distance, and a separation region defined between the first display cell and the second display cell, wherein the first display cell includes a pad portion having a concave portion and a convex portion;
forming a projection portion that corresponds to the concave portion in the separation region;
forming an alignment film on the display panel; and
rubbing the display panel on which the alignment film is formed in a predetermined direction.

19. The method of manufacturing a liquid crystal display of claim 18, wherein preparing the display panel comprises forming a gate electrode pattern on the display panel, forming a gate insulating film on the gate electrode pattern, forming a source/drain electrode pattern on the gate insulating film, and forming an interlayer insulating film on the source/drain electrode pattern.

20. The method of manufacturing a liquid crystal display of claim 19, wherein forming the projection portion on the separation region comprises at least one of forming a gate electrode pattern on the display panel, forming a gate insulating film on the gate electrode pattern, forming a source/drain electrode pattern on the gate insulating film, or forming an interlayer insulating film on the source/drain electrode pattern.
